(19) United States
(12) Patent Application Publication
(10) Pub. No.: US 2013/0003512 A1
(43) Pub. Date: Jan. 3, 2013

(54) OPTICAL PICKUP DEVICE AND OPTICAL DISC APPARATUS EQUIPPED WITH THE SAME

(76) Inventor: Kazuyoshi YAMAZAKI, Yamato (JP)

(21) Appl. No.: 13/533,086

(22) Filed: Jun. 26, 2012

(30) Foreign Application Priority Data
Jun. 29, 2011 (JP) 2011-144831

(51) Int. Cl. G11B 7/09; G11B 20/18; G11B 7/1353

(52) U.S. Cl. 369/44.23; 369/112.03; 369/53.28; G9B/7.113; G9B/20.046; G9B/7.062

(57) ABSTRACT

An optical pickup device includes a light source for emitting a light beam, an objective lens for collecting the light beam which is emitted and for irradiating an optical disc with the collected light beam, a diffraction element with a plurality of areas for dividing the light beam which is reflected from the optical disc, a detector with a plurality of detection parts for receiving the light beam which is made to diverge by the diffraction element, and a branching mirror for making the light beam branch into an optical path from the light source to the objective lens and an optical path from the objective lens to the detector. The diffraction element gives an aberration to the light beam diffracted at a specified area.

### CROSS-REFERENCES TO RELATED APPLICATIONS

This application relates to and claims priority from Japanese Patent Application No. 2011-144831, filed on Jun. 29, 2011, the entire disclosure of which is incorporated herein by reference.

### BACKGROUND

1. Field of the Invention

The invention relates to an optical pickup device and an optical disc apparatus equipped with the optical pickup device.

2. Description of Related Art

Conventionally, various optical pickup devices that realize stable tracking control when recording and reproducing information in multi layer optical discs with three or more layers have been introduced. For example, an optical head device (optical pickup device) is introduced, which has a diffracted light system for diffracting part of a light beam reflected and diffracted by an information recording medium, and a detector for receiving the light beam diffracted by the diffracted light system and the light beam which has permeated through the diffracted light system without being diffracted; wherein the diffracted light system is divided into a plurality of areas by a first division line and second division line extending in a first direction and a third division line and fourth division line extending in a second direction intersecting with the first direction; wherein areas outside the first division line and the second division line are a first sub-area and a second sub-area and areas outside the third division line and the fourth division line are a first main area and a second main area; wherein the detector has a 0th-order light detection part group for receiving the light beam, which has permeated through the diffracted light system without being diffracted, a main area detection part group for receiving the light beam diffracted at the first main area and the second main area, and a sub-area detection part group for receiving the light beam diffracted at the first sub-area and the second sub-area; wherein the information recording medium has a plurality of information layers; wherein each detection part of the main area detection part group is located between respective projection lines of the third division line and the fourth division line projected on the detector by means of stray light from an information layer adjacent to an information layer, on which the light beam converges, among the plurality of information layers; and wherein each detection part of the sub-area detection part group is located between respective projection lines of the first division line and the second division line projected on the detector by means of the stray light from an information layer adjacent to the information layer, on which the light beam converges, among the plurality of information layers (for example, see Japanese Patent Application Laid-Open (Kokai) Publication No. 2008-135151).

Also introduced as an example of an optical pickup device capable of obtaining stable servo signals, that is, both a focusing error signal and a tracking error signal, without being affected by stray light from another layer (or other layers) when recording and reproducing information in a multi layer optical disc is an optical pickup device designed so that reflected light from the multi layer optical disc is divided into a plurality of areas; wherein the divided optical beams form focal points at different positions on a detector and a focusing error signal is detected by a knife-edge method by using a plurality of the divided optical beams and a tracking error signal is detected by using a plurality of the divided optical beams; and wherein when a focal point is formed on a target layer, the divided areas of the optical beams and a servo signal detection surface of the detector are located so that stray light from the other layer(s) will not enter the servo signal detection surface of the detector. (for example, see Japanese Patent Application Laid-Open (Kokai) Publication No. 2009-170060).

### SUMMARY

Generally, the optical pickup device performs focus control by changing the position of an objective lens to a focus direction by detecting a focusing error signal and also performs tracking control by changing the direction of the objective lens to a disc radial direction (Rad direction) by detecting a tracking error signal in order to accurately irradiate a specified track in an optical disc with a spot. In other words, the position of the objective lens is controlled by those signals.

Regarding the tracking error signal of the above-mentioned signals, there is a significant problem to be solved when the optical disc is a multi layer disc composed of two or more recording layers. Specifically speaking, when the multi layer disc is used, not only the signal light reflected from a target recording layer, but also stray light reflected from a plurality of recording layers, which are not the target, enter the same detection parts; and if the signal light and the stray light enter the detection parts, two or more light beams interfere with each other and their variable component is detected by the tracking error signal.

Japanese Patent Application Laid-Open (Kokai) Publication No. 2008-135151 is designed to deal with the above-mentioned problem to be solved in such a manner that a tracking-error-signal-detecting detection part is located outside the stray light occurring from other layers around a focusing-error-signal-detecting detection part. Then, among the light beams which entered the hologram element, an area of the light beams entering in a disc radial direction (Rad direction) is diffracted in a disc tangential direction (the Tan direction) and an area of the light beams entering in the Tan direction is diffracted in the Rad direction. As a result, Japanese Patent Application Laid-Open (Kokai) Publication No. 2008-135151 can avoid the stray light and detect a stable tracking error signal. However, if the detection parts are located outside the stray light from the other layers and in the Tan direction and the Rad direction as in Japanese Patent Application Laid-Open (Kokai) Publication No. 2008-135151, the size of the detector becomes large. So, there remain problems to be solved about the cost of the detector and downsizing of the optical pickup device.

Furthermore, Japanese Patent Application Laid-Open (Kokai) Publication No. 2009-170060 is configured to avoid the stray light outside the tracking-error-signal-detecting detection part unlike Japanese Patent Application Laid-Open (Kokai) Publication No. 2008-135151. So, Japanese Patent Application Laid-Open (Kokai) Publication No. 2009-170060 is characterized in that its detector can be downsized significantly as compared to the detector of Japanese Patent Application Laid-Open (Kokai) Publication No. 2008-135151. However, Japanese Patent Application Laid-Open (Kokai) Publication No. 2009-170060 also has a problem related to the difficulty of cost reduction of a branching element that makes the light beam emitted from a laser diode branch into an outgoing path for the light beam to reach the optical disc and a returning path for the light beam to reflect off the optical disc and reach the detector.

Now, a prism or a mirror is used as a general branching element and it is desirable to use the mirror from the viewpoint of cost; however, the problem is that if convergent light permeates through an inclined flat plate (mirror), astigmatism and a coma aberration will occur.

In the case of Japanese Patent Application Laid-Open (Kokai) Publication No. 2008-135151, only 0th-order diffracted light and +1st-order diffracted light (or −1st-order diffracted light) are detected, so that the astigmatism and the coma aberration can be corrected by the hologram element. However, in the case of Japanese Patent Application Laid-Open (Kokai) Publication No. 2009-170060, both the +1st-order diffracted light and the −1st-order diffracted light are detected; and the correction method as disclosed in Japanese Patent Application Laid-Open (Kokai) Publication No. 2008-135151 can only correct either the +1st-order diffracted light or the −1st-order diffracted light and aberration in at least one of these types of diffracted light increases. Therefore, from the viewpoint of detection of a stable signal, it is desirable to use a prism as the branching element in the case of Japanese Patent Application Laid-Open (Kokai) Publication No. 2009-170060; however, Japanese Patent Application Laid-Open (Kokai) Publication No. 2009-170060 has a problem related to the difficulty of cost reduction.

The present invention was devised in consideration of the above-described circumstance and it is an object of the invention to provide an optical pickup device, which can obtain stable servo signals when recording and reproducing information in an information recording medium with a plurality of information recording surfaces, and which can realize downsizing and cost reduction, and an optical disc apparatus equipped with the above-described optical pickup device.

In order to achieve this object, provided according to an aspect of the present invention is an optical pickup device including: a light source for emitting a laser beam; an objective lens for collecting the light beam emitted from the light source and irradiating an optical disc with the collected light beam; a diffraction element with a plurality of areas for dividing the light beam reflected from the optical disc; a detector with a plurality of detection parts for receiving the light beam which is made to diverge by the diffraction element; and a mirror for making the light beam branch into an optical path from the light source to the objective lens and an optical path from the objective lens to the detector; wherein the diffraction element gives an aberration to the light beam diffracted at a specified area.

According to the present invention, an optical pickup device, which can obtain stable servo signals when recording and reproducing information in an information recording medium with a plurality of information recording surfaces, and which can realize downsizing and cost reduction, and an optical disc apparatus equipped with the above-described optical pickup device can be provided.

### BRIEF DESCRIPTION OF THE DRAWINGS

FIG. 1 illustrates the arrangement of an optical pickup device according to an embodiment of the present invention and an optical disc.

FIG. 2 is a schematic diagram for explaining an optical system of the optical pickup device according to an embodiment of the present invention.

FIG. 3 is a schematic diagram of a hologram element of the optical pickup device according to an embodiment of the present invention.

FIG. 4 is a schematic diagram showing the arrangement of detection parts of a detector for the optical pickup device according to an embodiment of the present invention.

FIG. 5 is a schematic diagram showing the relationship between signal light and stray light in the optical pickup device according to an embodiment of the present invention.

FIG. 6 is a schematic diagram showing hologram elements for an optical pickup device according to another embodiment of the present invention.

FIG. 7 is a diagram for explaining an optical disc apparatus (optical reproduction apparatus) equipped with the optical pickup device according to an embodiment of the present invention.

FIG. 8 is a diagram for explaining an optical disc apparatus (optical reproduction apparatus) equipped with the optical pickup device according to an embodiment of the present invention.

FIG. 9 is a schematic diagram showing a hologram element for an optical pickup device according to another embodiment of the present invention.

FIG. 10 is a schematic diagram showing the arrangement of detection parts of a detector for an optical pickup device according to another embodiment of the present invention.

FIG. 11 is a schematic diagram showing hologram elements for an optical pickup device according to another embodiment of the present invention.

FIG. 12 is a schematic diagram showing the arrangement of detection parts of a detector for an optical pickup device according to another embodiment of the present invention.

### DETAILED DESCRIPTION OF PREFERRED EMBODIMENTS

Next, an optical pickup device according to an embodiment of the present invention and an optical disc apparatus equipped with such an optical pickup device will be explained with reference to the attached drawings. Incidentally, while the embodiments described below are for the purpose of describing this invention, the invention is not limited only to these embodiments. Accordingly, this invention can be utilized in various ways unless the utilizations depart from the gist of the invention. Furthermore, each of the above drawings illustrates the thickness, size, enlargement and reduction ratios, and other details of each component; but for ease of comprehension, they are not to scale.

### Embodiment 1

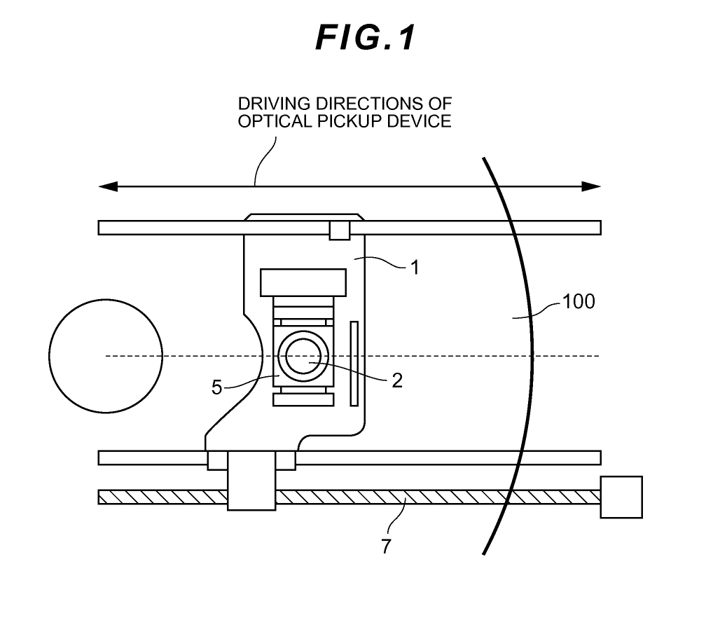

FIG. 1 is a diagram for explaining the arrangement of an optical pickup device according to Embodiment 1 of the present invention and an optical disc. As shown in FIG. 1, an optical pickup device 1 is configured so that it can be driven by a drive mechanism 7 in a radial direction (hereinafter referred to as the “Rad direction”) of an optical disc 100. Furthermore, an actuator 5 placed on the optical pickup device 1 is equipped with an objective lens 2 and the light is delivered from this objective lens 2 onto the optical disc 100. The light emitted from the objective lens 2 forms a spot on the optical disc 100 and is reflected by the optical disc 100. Then, a focusing error signal and a tracking error signal are generated by detecting this reflected light.

Incidentally, layers of the optical disc 100 include recording layers in a recording-type optical disc and reproduction layers of an optical disc for reproduction use only.

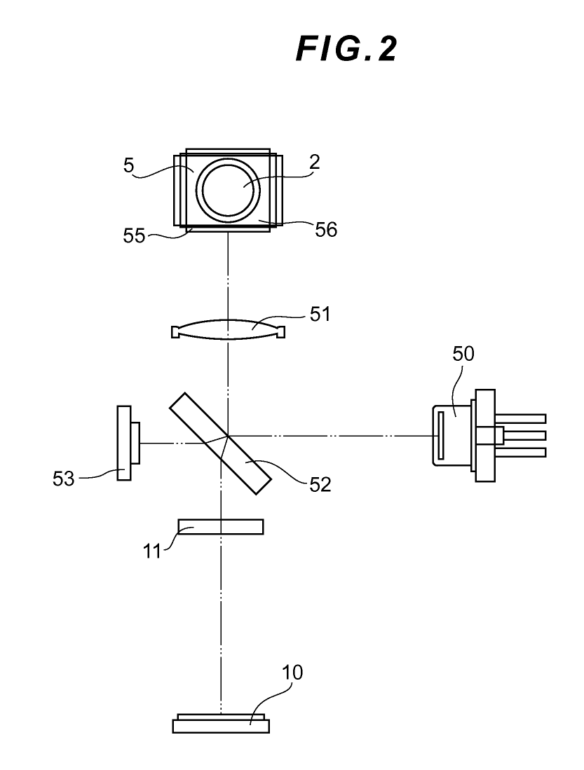

FIG. 2 is a schematic diagram for explaining an optical system of the optical pickup device 1 shown in FIG. 1. Now, an explanation about a BD (Blu-ray Disc) will be given, but any other recording method such as a DVD (Digital Versatile Disc) may be used. As shown in FIG. 2, the optical system of the optical pickup device 1 is configured by including: a laser diode 50; a branching mirror 52 located at a position where a light beam emitted from the laser diode 50 enters; a collimating lens 51 located at a position where the light beam reflected from the branching mirror 52 enters; a reflection mirror 55 located at a position where the light beam emitted from the collimating lens 51 enters; a quarter wave plate 56 located at a position where the light beam emitted from the reflection mirror 55 enters; an objective lens 2 located at a position where the light beam emitted from the quarter wave plate 56 enters; an actuator 5 equipped with the objective lens 2; a front monitor 53 where the light beam which has permeated through the branching mirror 52 enters; a hologram element 11 located on the other side of the branching mirror 52 opposite the collimating lens 51; and a detector located at a position where the light beam emitted from the hologram element 11 enters.

The light beam whose wavelength is approximately 405 nm is emitted as a diverging ray from the laser diode 50. The light beam emitted from the laser diode 50 reflects off the branching mirror 52 and enters the collimating lens 51. Incidentally, part of the light beam permeates through the branching mirror 52 and enters the front monitor 53. Generally, when recording information in a recording-type optical disc 100 such as a BD-RE or a BD-R, it is necessary to control the light quantity of the laser diode 50 with high precision in order to irradiate a recording surface of the optical disc 100 with a specified quantity of light. Therefore, when recording a signal in the recording-type optical disc 100, the front monitor 53 detects a change of the light quantity of the laser diode 50 and feeds back the detection result to a drive circuit (not shown) of the laser diode 50. As a result, the quantity of light on the optical disc 100 can be monitored.

The collimating lens 51 has a mechanism for driving the collimating lens 51 in an optical axial direction, changes a state of divergence and convergence of the light beam, which enters the objective lens 2, by driving the collimating lens 51 in the optical axial direction, and is used to compensate a spherical aberration due to a thickness error of a cover layer of the optical disc 100. The light beam emitted from the collimating lens 51 passes through the reflection mirror 55 and the quarter wave plate 56, and is made to converge on the optical disc 100 by the objective lens 2 mounted on the actuator 5.

The light beam reflected by the optical disc 100 passes through the objective lens 2, the quarter wave plate 56, the reflection mirror 55, the collimating lens 51, and the branching mirror 52, and enters the hologram element 11. When this happens, the light beam is divided by the hologram element 11 into a plurality of areas and the light beams of the respective areas travel in different directions and enter the detector 10.

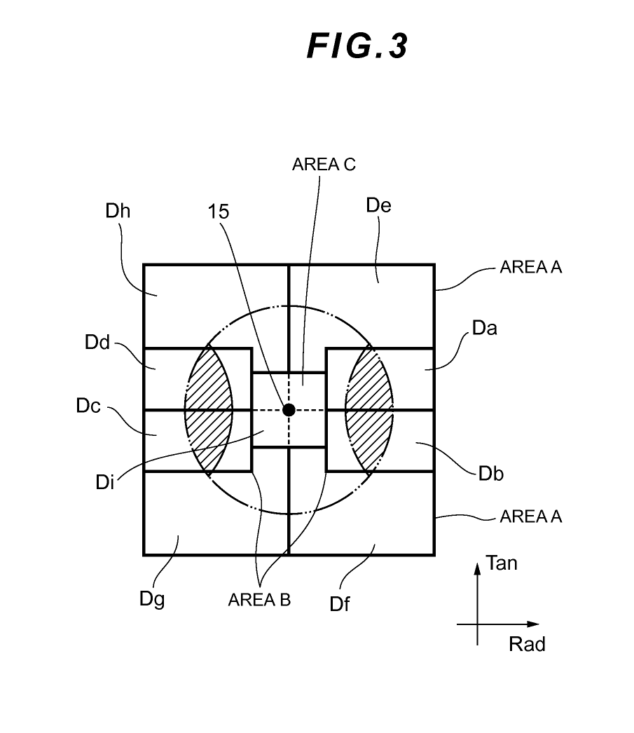

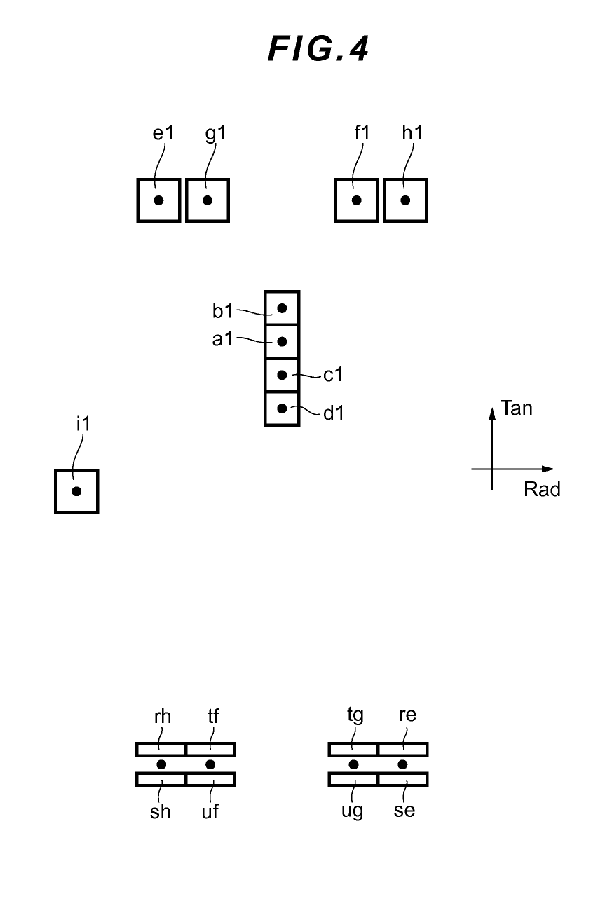

FIG. 3 is a schematic diagram of the hologram element 11. Referring to FIG. 3, solid lines indicates boundaries between areas, a chain double-dashed line indicates the outline of the light beam of the laser beam, and shaded areas indicate interference areas (push-pull patterns) of 0th-order diffracted light and ±1st-order diffracted light diffracted by the track of the optical disc. Furthermore, FIG. 4 is a schematic diagram showing the arrangement of detection parts of the detector 10 and black dots in FIG. 4 indicate signal light.

As shown in FIG. 3, the hologram element 11 is formed of: area A composed of areas De, Df, Dg, Dh where only the 0th-order diffracted light diffracted by the track on the optical disc 100 enters; area B composed of areas Da, Db, Dc, Dd where the 0th-order diffracted light and the ±1st-order diffracted light enter; and area C composed of area D1 including an approximate center of the hologram element 11. Regarding diffraction efficiency of the hologram element 11, for example, a ratio of the 0th-order diffracted light, the +1st-order diffracted light, and the −1st-order diffracted light with respect to the area B (areas Da, Db, Dc, Dd) and the area C (area Di) of the hologram element 11 is assumed to be 0:1:0; and a ratio of the 0th-order diffracted light, the +1st-order diffracted light, and the −1st-order diffracted light with respect to other areas is assumed to be 0:7:3. Furthermore, at least astigmatism is given in the area B so that the aberration of the +1st-order diffracted light from the area B (areas Da, Db, Dc, Dd) of the hologram element 11 decreases.

A plurality of detection parts are formed on the detector 10 and each detection part is irradiated with the light beams divided by the hologram element 11. Specifically speaking, detection parts a1, b1, c1, d1, e1, f1, g1, h1, i1 and focusing-error-signal-detecting detection parts re, se, tg, ug, tf, uf, rh, sh are formed on the detector 10 as shown in FIG. 4. Then, an electric signal is output from the detector 10 according to the quantity of light, with which these detection parts and focusing-error-signal-detecting detection part are irradiated, and a focusing error signal, a tracking error signal, and the RF signal which is a reproduction signal are generated by calculating the output from them.

The +1st-order diffracted light from the areas Da, Db, Dc, Dd, De, Df, Dg, Dh, Di of the hologram element 11 enters the detection parts a1, b1, c1, d1, e1, f1, g1, h1, i1, respectively, and the −1st-order diffracted light from the areas De, Df, Dg, Dh of the hologram element 11 enters the focusing-error-signal-detecting detection parts re, se, tg, ug, tf, uf, rh, sh, respectively. Incidentally, in Embodiment 1, the focusing error signal (FES), the tracking error signal (TES), and the RF signal (RF) are generated from signals A1, B1, C1, D1, E1, F1, G1, H1, I1, RE, SE, TG, UG, TF, UF, RH, SH, which are obtained from the detection parts a1, b1, c1, d1, e1, f1, g1, h1, i1 and the focusing-error-signal-detecting detection parts re, se, tg, ug, tf, uf, rh, sh, respectively, according to the operation indicated as the following Mathematical Formula 1.

FES=(RE+UG+UF+RH)−(SE+TG+TF+SH)

TES={(A1+B1)−(C1+D1)}−kt×{(E1+F1)−(G1+H1)}

RF=A1+B1+C1+D1+E1+F1+G1+H1+I1 (Mathematical Formula 1)

Incidentally, the letters kt is a coefficient for preventing the occurrence of a DC component in the tracking error signal when the position of the objective lens 2 is changed.

A detection method according to Embodiment 1 is to detect a stable tracking error signal even from a multi layer disc by employing the configuration to prevent stray light from entering the detection parts when recording or reproducing information in the multi layer disc in the same manner as the aforementioned Japanese Patent Application Laid-Open (Kokai) Publication No. 2009-170060.

Furthermore, a stray light avoiding method according to Embodiment 1 is to avoid the stray light in a disc tangential direction (hereinafter referred to as the “Tan direction”) when the areas of the hologram element 11 are separated from a light beam center 15 (see FIG. 3) of the hologram element 11 in the Tan direction. Then, the configuration that will not be affected by the stray light is realized by aligning the detection parts e1, f1, g1, h1 for detecting the light beams diffracted at the area A (areas De, Df, Dg, Dh), in a generally Rad direction as shown in FIG. 4, so that the stray light will not enter the detection parts even if the position of the objective lens 2 is changed in the Rad direction in order to follow the track of the optical disc 100.

On the other hand, when the areas of the hologram element 11 (the area B, that is, the areas Da, Db, Dc, Dd) are separated from the light beam center 15 (see FIG. 3) of the hologram element 11 in the Rad direction, the stray light is avoided in the Rad direction. Then, the detector 10 is configured as shown in FIG. 4 so that the influence of the stray light can be minimized even if the position of the objective lens 2 is changed, by aligning the detection parts a1, b1, c1, d1 for detecting the light beams, which have been diffracted at the area B, in a generally Tan direction.

Incidentally, in Embodiment 1, the convergent light permeates through the branching mirror 52, so that unlike Japanese Patent Application Laid-Open (Kokai) Publication No. 2009-170060, astigmatism and a coma aberration occur in the stray light because of the branching mirror 52; however, because a defocus amount and a spherical aberration amount are large, the stray light will not be affected by these aberrations.

Under this circumstance, the conventional technology uses a prism instead of the branching mirror 52 used in Embodiment 1. Although a prism is more expensive than a mirror, it is used because substitution of the mirror for the prism will cause defocus property degradation. Incidentally, astigmatism which will significantly affect the cause of the defocus property degradation will be explained below.

Generally, the light beam to which the astigmatism is given is characterized in that the defocus amount of the converging light beam in a specified direction is different from the defocus amount in a direction perpendicular to the specified direction. Since the astigmatism is given to the light beam, it is also characterized in that its spot diameter becomes larger than the light beam without any aberration. Therefore, if the astigmatism is given to the light beam, the light beam easily spreads out of the detection parts due to the defocus, thereby causing the defocus property degradation.

On the other hand, for example, it is possible to suppress the astigmatism of the light beam entering the detection parts by giving the astigmatism to the hologram element as in the invention described in Japanese Patent Application Laid-Open (Kokai) Publication No. 2008-135151 in order to improve the defocus property. However, in the case of the detection method which uses the ±1 st-order diffracted light as in Embodiment 1, as a general rule, only either the +1st-order diffracted light or the −1st-order diffracted light of the hologram element can be corrected and the aberration increases in at least one of those diffracted light beams.

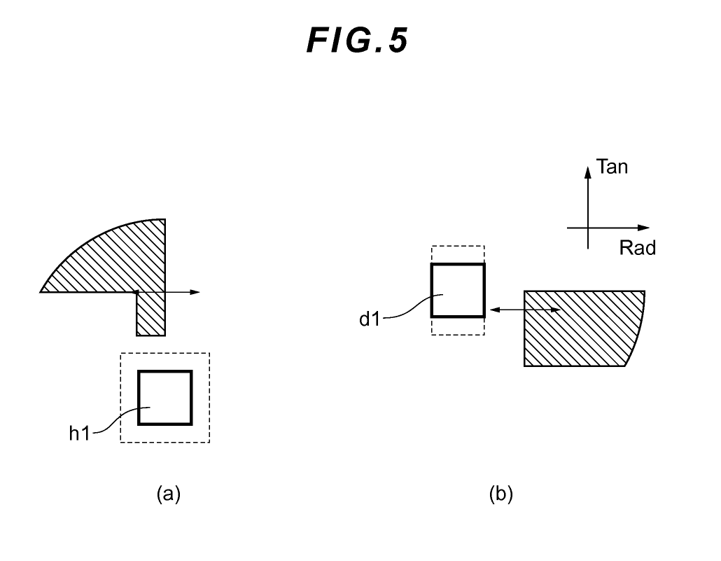

Furthermore, it is possible to enlarge the detection parts in order to improve the defocus property. FIG. 5 shows the relationship between the detection parts and the stray light; and FIG. 5(a) shows the relationship between the detection part h1 for detecting the light beam diffracted at the area Dh and the stray light and FIG. 5(b) shows the relationship between the detection part d1 for detecting the light beam diffracted at the area Dd and the stray light. Incidentally, solid lines in FIG. 5 indicate the detection parts h1 and d1, respectively, and shaded areas indicate the stray light. Also, arrows indicate positional change directions of the stray light when the position of the objective lens 2 is changed to the Rad direction.

Now, in the case of FIG. 5(a), if the stray light is avoided at the beginning, the stray light will not enter the detection path h1 even if the position of the objective lens 2 is changed; and, therefore, the detection part h1 can be enlarged to a certain degree in the Tan direction and the Rad direction as shown in a dashed line in FIG. 5(a). On the other hand, in the case of FIG. 5(b), even if the stray light is avoided at the beginning, the stray light will enter the detection part d1 due to the positional change of the objective lens 2; and, therefore, the detection part d1 can be enlarged in the Tan direction as shown in dashed lines in FIG. 5(b), but cannot be enlarged in the Rad direction. As a result, signals detecting the detection parts a1, b1, c1, d1 cannot improve the defocus property as compared to signals detecting the detection parts e1, f1, g1, h1. Furthermore, from the viewpoint of manufacturing of the optical pickup device, there is a problem of further defocus property degradation if misalignment of the detector 10 happens.

Therefore, if the prism is replaced with the branching mirror 52 in the configuration like the invention described in Japanese Patent Application Laid-Open (Kokai) Publication No. 2009-170060, there is a problem of the defocus property degradation. Furthermore, the astigmatism has been explained with respect to Embodiment 1; however, the coma aberration also actually occurs, so that the defocus property will further degrade.

So, Embodiment 1 is designed to detect the focusing error signal and the tracking error signal from the diffracted light from the area A (areas De, Df, Dg, Dh) of the hologram element 11, gives at least the astigmatism to the diffracted light from the area B (areas Da, Db, Dc, Dd), and detect only the +1st-order diffracted light in order to improve the defocus property degradation associated with the aberration.

With the configuration according to Embodiment 1, the aberration of the +1st-order diffracted light is suppressed and the defocus property is improved by giving the aberration to the light beam entering the area B of the hologram element 11 according to the aberration given to the branching mirror 52. Furthermore, the aberration increases in the −1st-order diffracted light from the area B of the hologram element 11 by the amount of aberration given to the +1st-order diffracted light from the same area; however, since the −1st-order diffracted light is not detected, the detector 10 will not be affected by the −1st-order diffracted light. Then, the focusing error signal and the tracking error signal are detected by using the ±1st-order diffracted light from the area A of the hologram element 11.

Incidentally, the branching mirror 52 gives the astigmatism and the coma aberration to the ±1st-order diffracted light from the area A of the hologram element 11; regarding the tracking error signal, the defocus property can be improved by enlarging the detection parts; and regarding the focusing error signal, asymmetry of the focusing error signal occurs due to the astigmatism, but defocusing does not occur, so that there will be no practical problem.

Even if the branching mirror 52 which is inexpensive is mounted instead of a prism in the configuration according to Embodiment 1 described above, at least astigmatism is given to only the area of the hologram element 11 where the +1st-order diffracted light is used, and the astigmatism is not given to the area where the ±1st-order diffracted light is used, thereby making it possible to detect stable signals. As a result, stable servo signals can be obtained when recording or reproducing information in the optical disc 100 (information recording medium) with a plurality of information recording surfaces; and the detector 10 of a small size can be provided and the optical pickup device 1 can be provided at low cost.

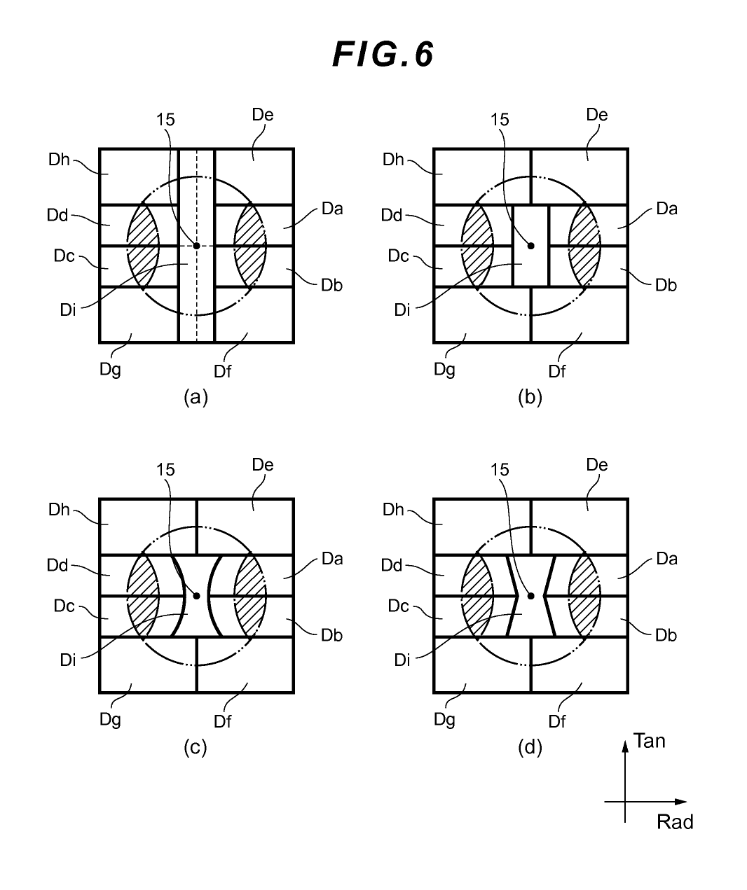

Incidentally, Embodiment 1 has described the case where the hologram element 11 configured as shown in FIG. 3 is used; however, the invention is not limited to such a configuration and, for example, patterns as shown in FIG. 6(a), FIG. 6(b), FIG. 6(c), FIG. 6(d) can also obtain the same advantageous effects.

Furthermore, Embodiment 1 has described the case where the hologram element 11 is located at a position where the light beam which has reflected off the optical disc 100 and permeated through the branching mirror 52 enters; however, the invention is not limited to this example and the same advantageous effect can be obtained, for example, by using a polarizing hologram element as the hologram element 11 and locating it at a position where the light beam which has reflected off the optical disc 100 enters before permeating through the branching mirror 52. Incidentally, there is no special limitation on a spherical aberration correction method.

Furthermore, the +1st-order diffracted light from the area B (areas Da, Db, Dc, Dd) of the hologram element 11 is detected according to Embodiment 1; however, since Embodiment 1 is configured so that the stray light of the multi layer disc (the optical disc 100) is avoided by correcting the aberration of the diffracted light entering the detection parts a1, b1, c1, d1, which are aligned in the Tan direction, and stable signals can be detected even upon the occurrence of defocusing, the diffracted light is not limited to the +1st-order diffracted light and may be the −1st-order diffracted light or diffracted light of other diffraction orders as long as the aberration can be corrected. Also, the diffraction efficiency explained in Embodiment 1 is merely one example and the diffraction efficiency is not limited to that example.

Furthermore, Embodiment 1 has explained a single recording system such as a BD as an example; however, the invention is not limited to this example and it is a matter of course that the above-described recording system may be combined with another recording system such as a DVD or a CD.

Furthermore, the area A and the area B of the hologram element 11 are not limited to those described above as long as the area A may be an area located along a straight line passing through the approximate center of the hologram element 11 and extending generally in parallel to the track of the optical disc 100 and the area B may be an area located along a straight line passing through the approximate center of the hologram element 11 and extending in a direction generally perpendicular to the track of the optical disc 100. Then, the method for dividing the area A and the area B of the hologram element 11 is not limited to that described in Embodiment 1. Incidentally, an aberration may be given to the area C.

Moreover, the laser diode 50 is used as a light source in Embodiment 1; however, the invention is not limited to this example and it is a matter of course that a light source of another configuration may be used as long as it could be used as the light source for the optical pickup device.

Furthermore, the hologram element 11 is used as a diffraction element in Embodiment 1; however, the invention is not limited to this example and the diffraction element is not limited to the hologram element 11 as long as the diffraction element has a plurality of areas for dividing the light beam which has reflected off the optical disc 100 in the optical pickup device.

Next, an optical disc apparatus (optical reproduction apparatus) in which the optical pickup device according to Embodiment 1 is mounted will be explained with reference to the relevant drawings.

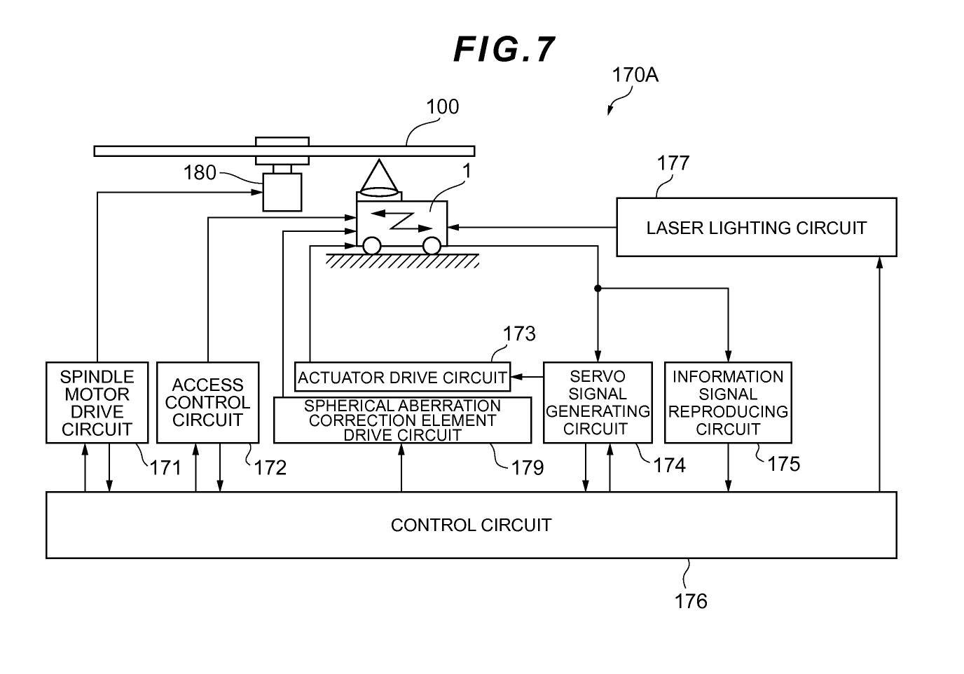

FIG. 7 is a diagram for explaining the optical disc apparatus (optical reproduction apparatus) according to Embodiment 1. As shown in FIG. 7, an optical disc apparatus 170A is configured by including the optical pickup device 1 according to Embodiment 1, a spindle motor 180 for rotating the optical disc 100, a spindle motor drive circuit 171 connected to the spindle motor 180, an access control circuit 172 connected to the optical pickup device 1, an actuator drive circuit 173, a servo signal generating circuit 174, an information signal reproducing circuit 175, a laser lighting circuit 177, a spherical aberration correction element drive circuit 179, and a control circuit 176 to which the spindle motor drive circuit 171, the access control circuit 172, the servo signal generating circuit 174, the information signal reproducing circuit 175, the laser lighting circuit 177, and the spherical aberration correction element drive circuit 179 are connected.

The optical pickup device 1 is provided with the drive mechanism 7 capable of driving the optical pickup device 1 along the Rad direction of the optical disc 100 so that its position can be controlled according to an access control signal from the access control circuit 172. A specified laser drive current is supplied from the laser lighting circuit 177 to the laser diode 50 located in the optical pickup device 1 and the laser beam with a specified quantity of light is emitted from this laser diode 50 at the time of reproduction of information. Incidentally, the laser lighting circuit 177 can be incorporated into the optical pickup device 1.

A signal output from the detector 10 in the optical pickup device 1 is sent to the servo signal generating circuit 174 and the information signal reproducing circuit 175. The servo signal generating circuit 174 generates servo signals such as a focusing error signal, a tracking error signal, and a tilt control signal based on the signal from the detector 10, drives the actuator 5 in the optical pickup device 1 via the actuator drive circuit 173 based on these signals, and controls the position of the objective lens 2. Furthermore, the information signal reproducing circuit 175 reproduces an information signal, which is recorded in the optical disc 100, based on the signal from the detector 10. Furthermore, part of the signals obtained at the servo signal generating circuit 174 and the information signal reproducing circuit 175 is sent to the control circuit 176.

This control circuit 176 is connected to the spindle motor drive circuit 171, the access control circuit 172, the servo signal generating circuit 174, the information signal reproducing circuit 175, the laser lighting circuit 177, and the spherical aberration correction element drive circuit 179 as described above and is designed to, for example, control rotations of the spindle motor 180, which rotates the optical disc 100, control the access direction and the access position, perform servo control of the objective lens 2, control the quantity of light emitted from the laser diode 50 in the optical pickup device 1, and correct the spherical aberration due to differences of the thickness of the optical disc 100.

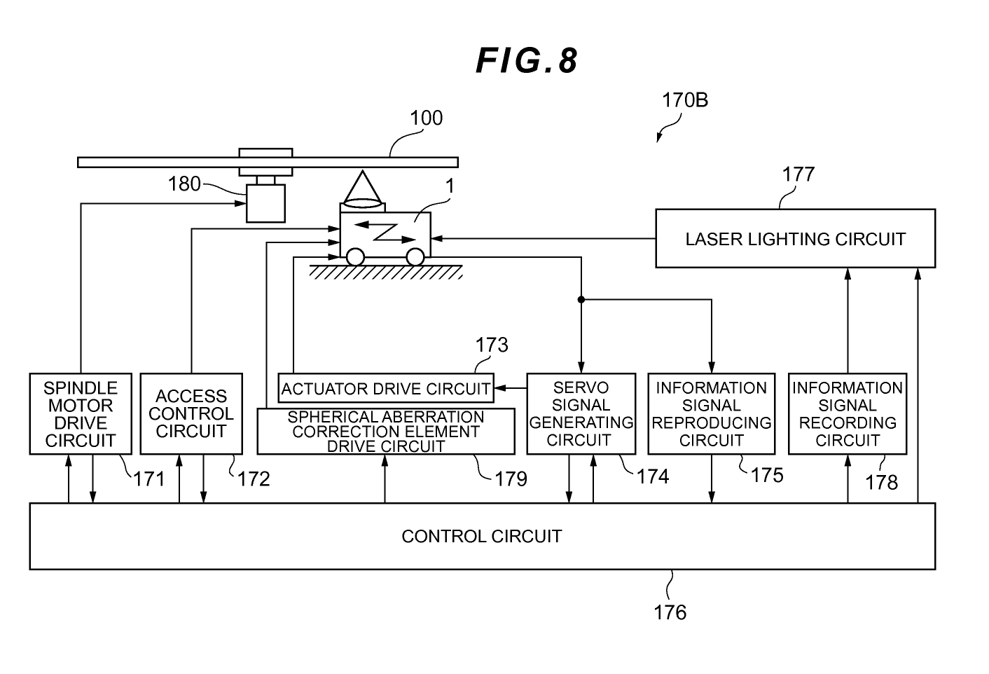

Incidentally, Embodiment 1 has described the optical disc apparatus 170A which only optically reproduces information as shown in FIG. 7; however, the invention is not limited to this example and the optical disc apparatus according to the present invention may be an optical disc apparatus 170B which optically records and reproduces information as shown in FIG. 8.

As shown in FIG. 8, the optical disc apparatus 170B is configured by including an information signal recording circuit 178 in the optical disc apparatus 170A according to Embodiment 1. Specifically speaking, the information signal recording circuit 178 is placed between the control circuit 176 and the laser lighting circuit 177 in the optical disc apparatus 170B and can control lighting of the laser lighting circuit 177 based on a recording control signal from the information signal recording circuit 178 and write desired information to the optical disc 100.

### Embodiment 2

Next, an optical pickup device according to Embodiment 2 of the present invention will be explained with reference to the relevant drawings.

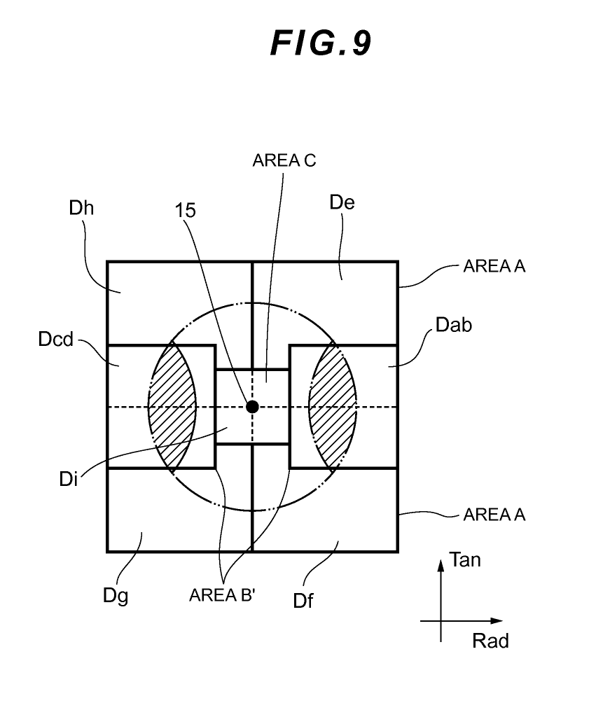

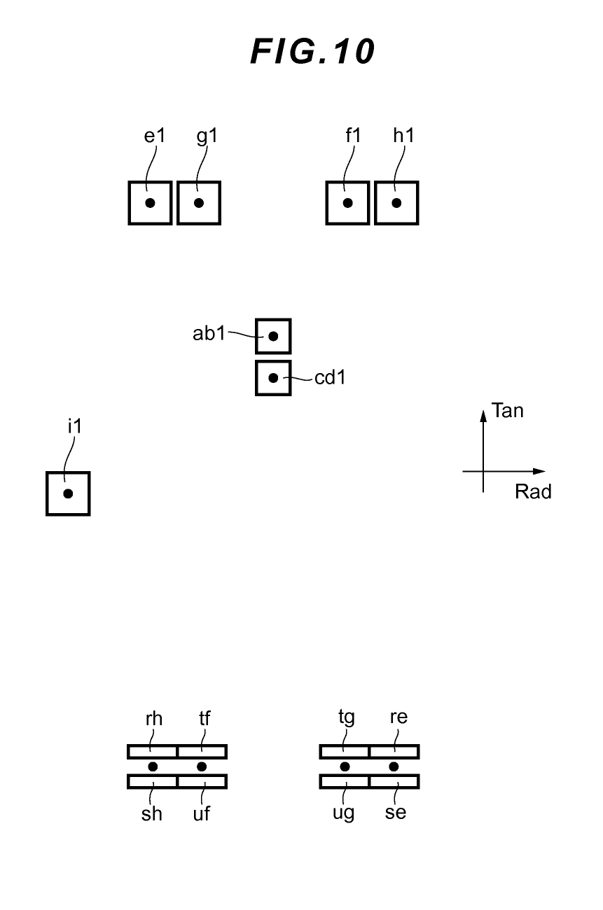

FIG. 9 is a schematic diagram showing a hologram element of the optical pickup device according to Embodiment 2 of the present invention and FIG. 10 is a schematic diagram showing the arrangement of detection parts of a detector for the optical pickup device shown in FIG. 9 and black dots in FIG. 10 indicate signal light. Incidentally, the same reference numerals as those used in Embodiment 1 are given to the same elements of the optical pickup device in Embodiment 2 as those explained in Embodiment 1 and any detailed explanation about them has been omitted.

The difference between the optical pickup device according to Embodiment 2 and the optical pickup device according to Embodiment 1 is that the area Da and the area Db of the hologram element 11 according to Embodiment 1 become one area Dab according to Embodiment 2 as shown in FIG. 9 and FIG. 10 and the area Dc and the area Dd of the hologram element 11 according to Embodiment 1 become one area Dcd according to Embodiment 2; and as a result, the detection part a1 and the detection part b1 according to Embodiment 1 become a detection part ab1 according to Embodiment 2 and the detection part c1 and the detection part d1 according to Embodiment 1 become a detection part cd1 according to Embodiment 2.

Specifically speaking, referring to FIG. 9, solid lines indicates boundaries between areas, a chain double-dashed line indicates the outline of the laser beam, and shaded areas indicate interference areas (push-pull patterns) between 0th-order diffracted light and ±1st-order diffracted light which are diffracted by the track of the optical disc 100. The hologram element 11 is formed of area A (areas De, Df, Dg, Dh), where only the 0th-order diffracted light of the diffracted light which has been diffracted by the track of the optical disc 100 enters, area B′ (areas Dab and Dcd), where the 0th-order diffracted light and the ±1st-order diffracted light of the diffracted light enters, and area C (area Di) including the approximate center of the hologram element 11.

Regarding the diffraction efficiency of the hologram element 11, for example, a ratio of the 0th-order diffracted light, the +1st-order diffracted light, and the −1st-order diffracted light with respect to the area B′(areas Dab and Dcd) and the area C (area Di) of the hologram element 11 is assumed to be 0:1:0 and a ratio of the 0th-order diffracted light, the +1st-order diffracted light, and the −1st-order diffracted light with respect to other areas is assumed to be 0:7:3. Also, at least astigmatism is given by the hologram element 11 in order to reduce the aberration of the +1st-order diffracted light from the area B′ (areas Dab and Dcd) of the hologram element 11.

Furthermore, detection parts ab1, cd1, e1, f1, g1, h1, i1 and focusing-error-signal-detecting detection parts re, se, tg, ug, tf, uf, rh, sh are formed on the detector 10 as shown in FIG. 10. Then, an electric signal is output from the detector 10 according to the quantity of light, with which these detection parts and focusing-error-signal-detecting detection parts are irradiated, and a focusing error signal, a tracking error signal, and an RF signal which is a reproduction signal are generated by calculating the output from them.

The +1st-order diffracted light from the areas Dab, Dcd, De, Df, Dg, Dh, Di of the hologram element 11 enters the detection parts ab1, cd1, e1, f1, g1, h1, i1, respectively, and the −1st-order diffracted light from the areas De, Df, Dg, Dh of the hologram element 11 enters the focusing-error-signal-detecting detection parts re, se, tg, ug, tf, uf, rh, sh, respectively. Incidentally, in Embodiment 2, the focusing error signal (FES), the tracking error signal (TES), and the RF signal (RF) are generated from signals AB1, CD1, E1, F1, G1, H1, I1, RE, SE, TG, UG, TF, UF, RH, SH, which are obtained from the detection parts ab1, cd1, e1, f1, g1, h1, i1 and the focusing-error-signal-detecting detection parts re, se, tg, ug, tf, uf, rh, sh, respectively, according to the operation indicated as the following Mathematical Formula 2.

FES=(RE+UG+UF+RH)−(SE+TG+TF+SH)

TES={(AB1)−(CD1)}−kt×{(E1+F1)−(G1+H1)}

RF=AB1+CD1+E1+F1+G1+H1+I1 (Mathematical Formula 2)

Incidentally, the letters kt is a coefficient for preventing the occurrence of a DC component in the tracking error signal when the position of the objective lens 2 is changed.

Furthermore, an optical system of the optical pickup device according to Embodiment 2 is the same as that according to Embodiment 1. Specifically speaking, the light beam emitted from the laser diode 50 passes through the same optical path as that of Embodiment 1 and enters the hologram element 11. When this happens, the light beam is divided by the hologram element 11 into a plurality of areas and the divided light beams travel in different directions depending on the respective areas and enter the detector 10.

A detection method according to Embodiment 2 is to detect a stable tracking error signal even from a multi layer disc by employing the configuration to prevent the stray light when recording or reproducing information in the multi layer disc from entering the detection parts in the same manner as in Japanese Patent Application Laid-Open (Kokai) Publication No. 2009-170060 mentioned earlier.

Furthermore, simply in Embodiment 2, the area Da and the area Db of the hologram element 11 according to Embodiment 1 become the area Dab and the area De and the area Dd according to Embodiment 1 become the area Dcd; and accordingly, the detection part a1 and the detection part b1 according to Embodiment 1 become the detection part ab1 and the detection part c1 and the detection part d1 according to Embodiment 1 become the detection part cd1. So, a stray light avoiding method is the same as that in Embodiment 1.

Specifically speaking, the stray light avoiding method according to Embodiment 2 is to avoid the stray light in the Tan direction when areas of the hologram element 11 are separated from the light beam center 15 (see FIG. 9) of the hologram element 11 in the Tan direction (the area A, that is, areas De, Df, Dg, Dh). Then, the configuration which will not be affected by the stray light is realized by aligning the detection parts e1, f1, g1, h1 for detecting the light beam, which has been diffracted at the area A (areas De, Df, Dg, Dh), in a generally Rad direction as shown in FIG. 10, so that the stray light will not enter the detection parts even if the position of the objective lens 2 is changed in the Rad direction in order to follow the track of the optical disc 100.

On the other hand, if areas of the hologram element 11 are separated from the light beam center 15 (see FIG. 9) of the hologram element 11 in the Rad direction (the area B′, that is, the areas Dab and Dcd), the stray light is avoided in the Rad direction. Then, the configuration which can minimize the influence of the stray light is realized by aligning the detection parts ab1 and cd1 for detecting the light beam, which has been diffracted at the area B′, in a generally Tan direction as shown FIG. 10 even if the position of the objective lens 2 is changed.

Incidentally, in Embodiment 2, the convergent light permeates through the branching mirror 52 in the same manner as in Embodiment 1, so that unlike the invention described in Japanese Patent Application Laid-Open (Kokai) Publication No. 2009-170060, astigmatism and a coma aberration are caused in the stray light because of the branching mirror 52, but such aberrations will not affect the stray light because a defocus amount and a spherical aberration amount are large.

Now, in Embodiment 2, the focusing error signal and the tracking error signal are detected from the diffracted light from the area A (areas De, Df, Dg, Dh) of the hologram element 11 and at least astigmatism is given to the diffracted light from the area B′ (the areas Dab and Dcd) and only the +1st-order diffracted light is detected in order to improve the defocus property degradation associated with the occurrence of the aberration as a result of mounting the mirror (the branching mirror 52) as the branching element.

With the configuration according to Embodiment 2, the aberration of the +1st-order diffracted light is suppressed and the defocus property is improved by giving the aberration to the light beam entering the area B′(the areas Dab and Dcd) of the hologram element 11 according to the aberration given by the branching mirror 52. Furthermore, the aberration in the −1st-order diffracted light from the area B′ (the areas Dab and Dcd) of the hologram element 11 increases by the amount of aberration given to the +1st-order diffracted light from the same area; however, since the −1st-order diffracted light is not detected, the detector will not be affected by the −1st-order diffracted light. Then, the focusing error signal and the tracking error signal are detected by using the +1st-order diffracted light from the area A (areas De, Df, Dg, Dh) of the hologram element 11.

Incidentally, the branching mirror 52 gives the astigmatism and the coma aberration to the +1st-order diffracted light from the area A (areas De, Df, Dg, Dh) of the hologram element 11; regarding the tracking error signal, the defocus property can be improved by enlarging the detection parts; and regarding the focusing error signal, asymmetry of the focusing error signal occurs due to the astigmatism, but defocusing does not occur, so that there will be no practical problem.

Even if the mirror (the branching mirror 52) is mounted as the branching element in the configuration according to Embodiment 2 as described above, at least astigmatism is given to only the area where the +1st-order diffracted light of the hologram element 11 is used, and the astigmatism is not given to the area where the ±1st-order diffracted light is used, thereby making it possible to detect stable signals. As a result, stable servo signals can be obtained when recording or reproducing information in the optical disc 100 (information recording medium) with a plurality of information recording surfaces; and the detector 10 of a small size can be provided and the optical pickup device can be provided at low cost. Furthermore, with the configuration according to Embodiment 2, the area Dab of the hologram element 11 is not divided into the area Da and the area Db as it is in Embodiment 1; and the area Dcd is not divided into the area Dc and the area Dd as it is in Embodiment 1. So, it is unnecessary to consider the formation of the boundary between the area Da and the area Db and the boundary between the area Dc and the area Dd, so that the configuration of Embodiment 2 is simpler than that of Embodiment 1 and the optical pickup device according to Embodiment 2 can be easily manufactured.

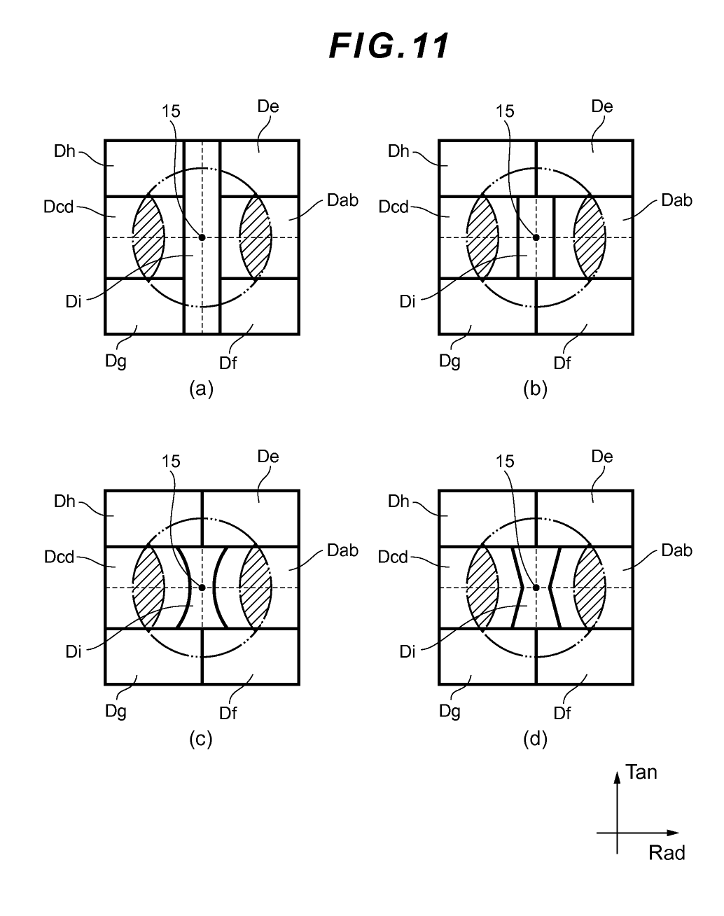

Incidentally, Embodiment 2 has described the case where the hologram element 11 configured as shown in FIG. 9 is used; however, the invention is not limited to this configuration and hologram elements of patterns as shown in, for example, FIG. 11(a), FIG. 11(b), FIG. 11(c), and FIG. 11(d) can obtain the same advantageous effects.

Moreover, in Embodiment 2, the hologram element 11 is located at the same position as in Embodiment 1; however, the invention is not limited to this example and the same advantageous effects can be obtained by, for example, using a polarizing hologram element as the hologram element 1 and locating it at a position where the light beam reflected by the optical disc 100 enters before permeating through the branching mirror 52. Incidentally, there is no particular limitation on a spherical aberration correction method.

Furthermore, in Embodiment 2, the +1st-order diffracted light from the area B′ (the areas Dab and Dcd) of the hologram element 11 is detected; however, since Embodiment 2 is configured so that the stray light of the multi layer disc (the optical disc 100) is avoided and stable signals can be detected even if defocusing occurs, by correcting the aberration of the diffracted light which enters the detection parts a1, b1, c1, d1 aligned in the Tan direction, the diffracted light to be detected is not limited to the +1st-order diffracted light and may be the −1st-order diffracted light or diffracted light of other diffraction orders as long as the aberration can be corrected. Also, the diffraction efficiency explained in Embodiment 2 is merely one example and the invention is not limited to that example.

Furthermore, it is a matter of course that the above-described recording system according to Embodiment 2 may be combined with another recording system such as a DVD or a CD in the same manner as in the case of Embodiment 1.

Furthermore, the area A and the area B′ of the hologram element 11 are not limited to those described above as long as the area A may be an area located along a straight line passing through the approximate center of the hologram element 11 and extending generally in parallel to the track of the optical disc 100 and the area B′ may be an area located along a straight line passing through the approximate center of the hologram element 11 and extending in a direction generally perpendicular to the track of the optical disc 100. Also, the method for dividing the area A and the area B′ of the hologram element 11 is not limited to that explained in Embodiment 2. Incidentally, an aberration may be given with respect to the area C.

### Embodiment 3

Next, an optical pickup device according to Embodiment 3 of the present invention will be explained with reference to the relevant drawings.

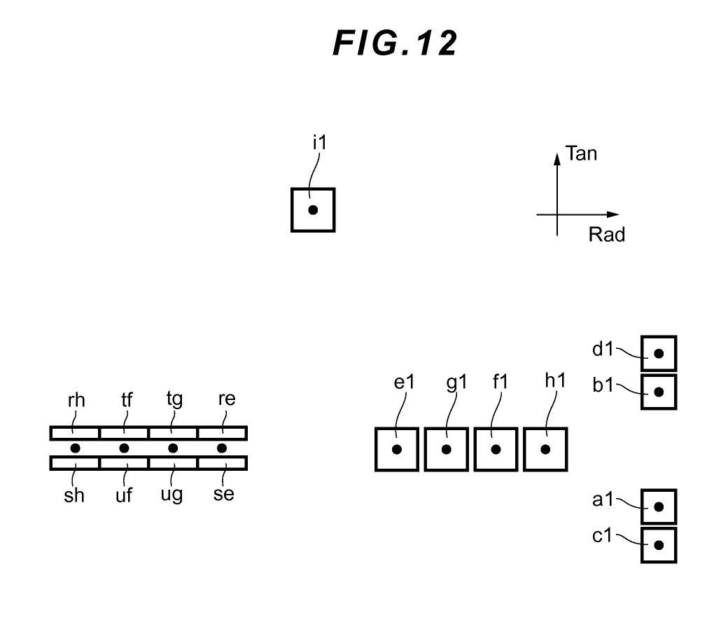

FIG. 12 is a schematic diagram showing the arrangement of detection parts of a detector for an optical pickup device according to Embodiment 3 of the present invention and black dots in FIG. 12 indicate signal light. Incidentally, the same reference numerals as those used in Embodiments 1 and 2 are given to the same elements in Embodiment 3 as explained with respect to the optical pickup devices according to Embodiments 1 and 2 and any detailed explanation about them has been omitted.

The difference between an optical pickup device according to Embodiment 3 and the optical pickup device according to Embodiment 1 is the arrangement of detection parts and focusing-error-signal-detecting detection parts. Specifically speaking, detection parts a1, b1, e1, d1, e1, f1, g1, h1, i1 and focusing-error-signal-detecting detection parts re, se, tg, ug, tf, uf, rh, sh are formed on the detector 10 in the arrangement as shown in FIG. 12 and each detection part is irradiated with the light beam divided by the hologram element 11. Then, an electric signal is output from the detector 10 according to the quantity of light, with which those detection parts and focusing-error-signal-detecting detection parts are irradiated, and a focusing error signal, a tracking error signal, and an RF signal, which is a reproduction signal, are generated by calculating the output from them in the same manner as in Embodiment 1.

The +1st-order diffracted light from the areas Da, Db, Dc, Dd, De, Df, Dg, Dh, Di of the hologram element 11 enters the detection parts a1, b1, c1, d1, e1, f1, g 1, h1, i1, respectively, and the −1st-order diffracted light from the areas De, Df, Dg, Dh of the hologram element 11 enters the focusing-error-signal-detecting detection parts re, se, tg, ug, tf, uf, rh, sh, respectively.

Incidentally, in Embodiment 3 in the same manner as in Embodiment 1, the focusing error signal (FES), the tracking error signal (TES), and the RF signal (RF) are generated from signals A1, B1, C1, D1, E1, F1, G1, H1, I1, RE, SE, TG, UG, TF, UF, RH, SH, which are obtained from the detection parts a1, b1, c1, d1, e1, f1, g1, h1, i1 and the focusing-error-signal-detecting detection parts re, se, tg, ug, tf, uf, rh, sh, respectively, according to the operation indicated as Mathematical Formula 1 mentioned earlier.

Furthermore, in Embodiment 3 in the same manner as in Embodiment 1, the stray light avoiding method is to avoid the stray light in the Tan direction when areas of the hologram element 11 are separated from the light beam center 15 (see FIG. 3) of the hologram element 11 in a disc tangential direction (hereinafter referred to as the “Tan direction”) (the area A, that is, the areas De, Df, Dg, Dh). Then, the configuration which will not be affected by the stray light is realized by aligning the detection parts e1, f1, g1, h1 for detecting the light beam, which has been diffracted at the area A (areas De, Df, Dg, Dh), in a generally Rad direction as shown in FIG. 12, so that the stray light will not enter the detection parts even if the position of the objective lens 2 is changed in the Rad direction in order to follow the track of the optical disc 100.

On the other hand, if areas of the hologram element 11 are separated from the light beam center 15 (see FIG. 3) of the hologram element 11 in the Rad direction (the area B, that is, the areas Da, Db, Dc, Dd), the stray light is avoided in the Rad direction. Then, the configuration which can minimize the influence of the stray light is realized by aligning the detection parts a1, b1, c1, d1 for detecting the light beam, which has been diffracted at the area B, in a generally Tan direction as shown FIG. 12 even if the position of the objective lens 2 is changed.

Incidentally, with the configuration according to Embodiment 3 in the same manner as the configuration according to Embodiment 1, the aberration of the +1st-order diffracted light is suppressed and the defocus property is improved by giving an aberration to the light beam entering the areas Da, Db, Dc, Dd of the hologram element 11 according to the aberration given by the branching mirror 52. Furthermore, the aberration in the −1st-order diffracted light from the areas Da, Db, Dc, Dd of the hologram element 11 increases by the amount of aberration given to the +1st-order diffracted light from the same area; however, since the −1st-order diffracted light is not detected, the detector will not be affected by the −1st-order diffracted light. Then, the focusing error signal and the tracking error signal are detected by using the ±1st-order diffracted light from the De, Df, Dg, Dh of the hologram element 11.

Therefore, even if the branching mirror 52 which is inexpensive is mounted instead of a prism, at least astigmatism is given to only the area where the +1st-order diffracted light of the hologram element 11 is used, and the astigmatism is not given to the area where the ±1st-order diffracted light is used, thereby making it possible to detect stable signals. As a result, stable servo signals can be obtained when recording or reproducing information in the optical disc 100 (information recording medium) with a plurality of information recording surfaces; and the detector 10 of a small size can be provided and the optical pickup device can be provided at low cost.

Incidentally, the present invention is not limited to Embodiments 1 to 3 described above, and includes various variations. For example, the aforementioned Embodiments 1 to 3 have been described in detail in order to explain the invention in an easily comprehensible manner and are not necessarily limited to those having all the configurations explained above. Furthermore, part of the configuration of a certain embodiment can be replaced with the configuration of another embodiment and the configuration of another embodiment can be added to the configuration of a certain embodiment. Also, part of the configuration of each embodiment can be deleted, or added to, or replaced with, the configuration of another configuration.

What is claimed is:

1. An optical pickup device comprising:
a light source for emitting a laser beam;
an objective lens for collecting the light beam emitted from the light source and irradiating an optical disc with the collected light beam;
a diffraction element with a plurality of areas for dividing the light beam reflected from the optical disc;
a detector with a plurality of detection parts for receiving the light beam which is made to diverge by the diffraction element; and
a mirror for making the light beam branch into an optical path from the light source to the objective lens and an optical path from the objective lens to the detector;
wherein the diffraction element gives an aberration to the light beam diffracted at a specified area.

2. The optical pickup device according to claim 1, wherein the diffraction element has a first area, a second area, and a third area;
wherein the first area is located along a straight line passing through an approximate center of the diffraction element and extending in a direction generally parallel to a track of the optical disc;
wherein the second area is located along a straight line passing through the approximate center of the diffraction element and extending in a direction generally perpendicular to the track of the optical disc;
wherein the third area is an area including the approximate center of the diffraction element; and
wherein the diffraction element gives an aberration to only the light beam diffracted at the second area.

3. The optical pickup device according to claim 1, wherein the diffraction element has a first area, a second area, and a third area;
wherein the first area is located along a straight line passing through an approximate center of the diffraction element and extending in a direction generally parallel to a track of the optical disc;
wherein the second area is located along a straight line passing through the approximate center of the diffraction element and extending in a direction generally perpendicular to the track of the optical disc;
wherein the third area is an area including the approximate center of the diffraction element; and
wherein the diffraction element gives an aberration to only the light beam diffracted at the second area and the third area.

4. The optical pickup device according to claim 1, wherein the diffraction element has a first area, a second area, and a third area;
wherein the third area is an area including an approximate center of the diffraction element;
wherein regarding the diffracted light which is diffracted by a track of the optical disc, only 0th-order diffracted light enters the first area and the 0th-order diffracted light and ±1st-order diffracted light enter the second area; and
wherein the diffraction element gives an aberration to only the light beam diffracted at the second area.

5. The optical pickup device according to claim 1, wherein the diffraction element has a first area, a second area, and a third area;
wherein the third area is an area including the approximate center of the diffraction element;
wherein regarding the diffracted light which is diffracted by a track of the optical disc, only 0th-order diffracted light enters the first area and the 0th-order diffracted light and ±1st-order diffracted light enter the second area; and
wherein the diffraction element gives an aberration to only the light beam diffracted at the second area and the third area.

6. The optical pickup device according to claim 1, wherein the aberration given by the diffraction element is at least astigmatism.

7. The optical pickup device according to claim 6, wherein the aberration given by the diffraction element is astigmatism and a coma aberration.

8. The optical pickup device according to claim 1, wherein the diffraction element has a first area, a second area, and a third area; and
wherein the detector detects either +1st-order diffracted light or −1st-order diffracted light of the second area.

9. The optical pickup device according to claim 1, wherein the diffraction element has a first area, a second area, and a third area; and
wherein at least two detection parts for detecting the light beam diffracted at the first area are aligned along a generally straight light in a direction generally perpendicular to the track of the optical disc.

10. The optical pickup device according to claim 1, wherein the diffraction element has a first area, a second area, and a third area; and
wherein at least two detection parts for detecting the light beam diffracted at the second area are aligned along a generally straight light in a direction generally parallel to the track of the optical disc.

11. The optical pickup device according to claim 1, wherein the diffraction element has a first area, a second area, and a third area; and
wherein a focusing error signal of a knife-edge method is detected from a signal detecting the light beam diffracted at the first area.

12. The optical pickup device according to claim 1, wherein the diffraction element has a first area, a second area, and a third area; and
wherein the area of a detection part of the detector for detecting the light beam diffracted at the first area is larger than the area of a detection part of the detector for detecting the light beam diffracted at the second area.

13. An optical disc apparatus equipped with:
the optical pickup device stated in any one of claims 1 to 12;
a laser lighting circuit for driving the light source diode in the optical pickup device;
a servo signal generating circuit for generating a focusing error signal and a tracking error signal by using a signal detected by the detector in the optical pickup device; and
an information signal reproducing circuit for reproducing an information signal recorded in the optical disc.
